(19) United States
(12) Patent Application Publication
(10) Pub. No.: US 2026/0065505 A1
(43) Pub. Date: Mar. 5, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Tsukasa MATSUO, Tokyo (JP); Jiro ABE, Tokyo (JP); Yuya MATSUMOTO, Tokyo (JP); Kazumine OGURA, Tokyo (JP)

(73) Assignee: NEC Corporation, Tokyo (JP)

(21) Appl. No.: 19/308,479

(22) Filed: Aug. 25, 2025

(30) Foreign Application Priority Data
Sep. 2, 2024 (JP) 2024-150971

(51) Int. Cl. G06T 7/73; G06T 7/00; G06T 7/55

(52) U.S. Cl. CPC G06T 7/74; G06T 7/0002; G06T 7/55; G06T 2200/04; G06T 2207/10016; G06T 2207/10028; G06T 2207/30244

(57) ABSTRACT

An information processing apparatus includes a data acquisition unit that acquires moving image data generated by moving image capturing from a specific portion to an inspection portion of an object and holding a camera posture at a time of capturing as a first camera posture for each frame, a camera posture calculation unit that collates a frame including the specific portion with three-dimensional data of the object, calculates a camera posture in the specific portion in the three-dimensional data as a second camera posture, and calculates a second camera posture of the inspection portion on the three-dimensional data using a first camera posture of a frame of the inspection portion and a second camera posture of the specific portion on the three-dimensional data, and a position identification unit that identifies a position of the inspection portion on the three-dimensional data using the second camera posture of the inspection portion.

This application is based upon and claims the benefit of priority from Japanese Patent Application No. 2024-150971, filed on Sep. 2, 2024, the disclosure of which is incorporated herein in its entirety by reference.

### TECHNICAL FIELD

The present disclosure relates to an information processing apparatus and an information processing method for collating three-dimensional point cloud data of an object with a captured image of the object, and further relates to a computer-readable recording medium in which a program for achieving the three-dimensional point cloud data and the captured image is recorded.

### BACKGROUND ART

In recent years, there has been a demand for efficient management of infrastructures such as bridges. For this reason, as image processing techniques have been improved in recent years, a technique for managing a deteriorated portion of an infrastructure using three-dimensional point cloud data has been proposed (see, for example, JP 2020-154466 A).

Specifically, J P 2020-154466 A discloses an apparatus capable of displaying three-dimensional point cloud data of an infrastructure on a screen and pasting an image captured at the time of inspection on a relevant portion of the three-dimensional point cloud data on the screen. According to the apparatus disclosed in JP 2020-154466 A, the manager can easily grasp a deteriorated portion and the like of the infrastructure, and can efficiently manage the infrastructure.

### SUMMARY

Meanwhile, in order to efficiently manage the apparatus disclosed in JP 2020-154466 A, it is necessary to accurately align an imaging target portion of an image captured at the time of inspection with a relevant portion of three-dimensional point cloud data. In order to accurately perform this alignment, it is necessary to construct the three-dimensional point cloud data of the infrastructure so that there is no missing portion.

However, since the infrastructure is huge, it is necessary to perform measurement at a very large number of places in order to construct the three-dimensional point cloud data so as not to have a defective portion, and it takes a huge amount of time. For this reason, it is very difficult to construct the three-dimensional point cloud data of the infrastructure so that there is no defect portion.

An object of the present disclosure is to enable alignment between a capturing portion of an image obtained by capturing an object and a relevant portion of three-dimensional data without being affected by a state of the three-dimensional data of the object.

In order to achieve the above object, an information processing apparatus according to an aspect of the present disclosure includes
a data acquisition unit that acquires moving image data generated by moving image capturing from a specific portion to an inspection portion of an object and holding a camera posture at a time of moving image capturing as a first camera posture for each frame,
a camera posture calculation unit configured to execute
collating a frame including the specific portion in the moving image data with three-dimensional data of the object, and calculating a camera posture in a portion relevant to the specific portion in the three-dimensional data as a second camera posture, and
calculating a second camera posture in a portion relevant to the inspection portion on the three-dimensional data using a first camera posture held in a frame including the inspection portion and a second camera posture in a portion relevant to the specific portion on the three-dimensional data,
a camera posture calculation unit, and
a position identification unit that identifies a position of a portion relevant to the inspection portion on the three-dimensional data using a second camera posture in a portion relevant to the inspection portion on the three-dimensional data.

In order to achieve the above object, an information processing method according to an aspect of the present disclosure includes
a data acquisition step for acquiring moving image data generated by moving image capturing from a specific portion to an inspection portion of an object and holding a camera posture at a time of moving image capturing as a first camera posture for each frame,
a camera posture calculation step for executing
collating a frame including the specific portion in the moving image data with three-dimensional data of the object, and calculating a camera posture in a portion relevant to the specific portion in the three-dimensional data as a second camera posture, and
calculating a second camera posture in a portion relevant to the inspection portion on the three-dimensional data using a first camera posture held in a frame including the inspection portion and a second camera posture in a portion relevant to the specific portion on the three-dimensional data;
a camera posture calculation step; and
a position identification step for identifying a position of a portion relevant to the inspection portion on the three-dimensional data using a second camera posture in a portion relevant to the inspection portion on the three-dimensional data.

Furthermore, in order to achieve the above object, a computer-readable recording medium according to an aspect of the present disclosure has recorded therein a program containing commands for causing a computer to execute
a data acquisition step for acquiring moving image data generated by moving image capturing from a specific portion to an inspection portion of an object and holding
a camera posture at a time of moving image capturing as a first camera posture for each frame,
a camera posture calculation step for executing
collating a frame including the specific portion in the moving image data with three-dimensional data of the object, and calculating a camera posture in a portion relevant to the specific portion in the three-dimensional data as a second camera posture, and
calculating a second camera posture in a portion relevant to the inspection portion on the three-dimensional data using a first camera posture held in a frame including the inspection portion and a second camera posture in a portion relevant to the specific portion on the three-dimensional data;
a camera posture calculation step; and
a position identification step for identifying a position of a portion relevant to the inspection portion on the three-dimensional data using a second camera posture in a portion relevant to the inspection portion on the three-dimensional data.

As described above, according to the present disclosure, it is possible to align a capturing portion of an image obtained by capturing an object with a relevant portion of three-dimensional data without being affected by a state of the three-dimensional data of the object.

### BRIEF DESCRIPTION OF THE DRAWINGS

FIG. 1 is a configuration diagram illustrating a schematic configuration of an example of an information processing apparatus;

FIG. 2 is a configuration diagram specifically illustrating a configuration of an example of an information processing apparatus;

FIG. 3 is a diagram illustrating an example of a state of capturing moving image data used in an information processing apparatus;

FIG. 4 is a diagram for explaining an example of processing in a camera posture calculation unit 12;

FIG. 5 is a flowchart illustrating an example of an operation of the information processing apparatus 10; and

FIG. 6 is a block diagram illustrating an example of a computer that achieves the information processing apparatus.

### EXAMPLE EMBODIMENT

### Example Embodiment

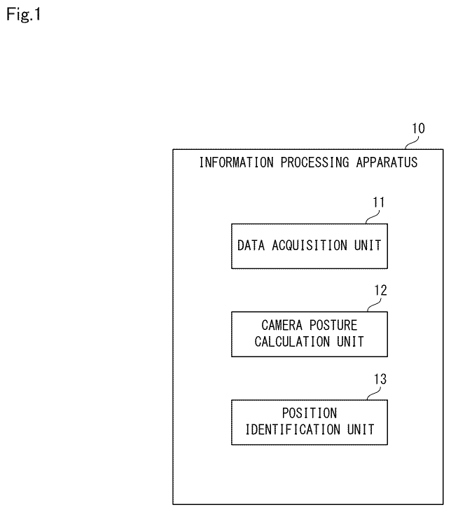

Hereinafter, in example embodiments, an information processing apparatus, an information processing method, and a program will be described with reference to FIGS. 1 to 6.

### [Apparatus Configuration]

First, a schematic configuration of an example of the information processing apparatus will be described with reference to FIG. 1. FIG. 1 is a configuration diagram illustrating a schematic configuration of an example of the information processing apparatus.

An information processing apparatus 10 illustrated in FIG. 1 is an apparatus for collating three-dimensional point cloud data of an object with a captured image of the object, and is an image collation apparatus. As illustrated in FIG. 1, the information processing apparatus 10 includes a data acquisition unit 11, a camera posture calculation unit 12, and a position identification unit 13.

The data acquisition unit 11 acquires moving image data of the object. The moving image data is generated by moving image capturing from a specific portion to an inspection portion of the object. The moving image data holds the camera posture at the time of capturing the moving image as a first camera posture for each frame.

The camera posture calculation unit 12 collates a frame including a specific portion in the moving image data with the three-dimensional data of the object. Then, the camera posture calculation unit 12 calculates the camera posture at a portion relevant to the specific portion on the three-dimensional data as a second camera posture by using the collation result.

Further, the camera posture calculation unit 12 calculates the second camera posture in the portion relevant to the inspection portion on the three-dimensional data using the first camera posture held in the frame including the inspection portion and the second camera posture in the portion relevant to the specific portion on the three-dimensional data.

The position identification unit 13 identifies the position of the portion relevant to the inspection portion on the three-dimensional data using the second camera posture in the portion relevant to the inspection portion on the three-dimensional data.

As described above, in the information processing apparatus 10, the second camera posture of the portion relevant to the inspection portion of the object on the three-dimensional data is calculated from the first camera posture of the inspection portion obtained from the moving image data and the second camera posture of the specific portion. That is, in the information processing apparatus 10, even if the data of the portion relevant to the inspection portion on the three-dimensional data is missing, the second camera posture of this portion is calculated. Therefore, according to the information processing apparatus 10, it is possible to align a capturing portion of an image obtained by capturing an object with a relevant portion of three-dimensional data without being affected by a state of the three-dimensional data of the object.

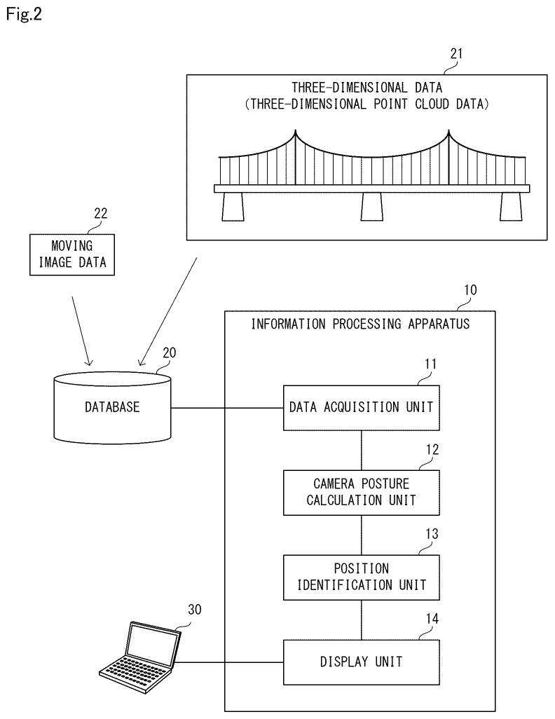

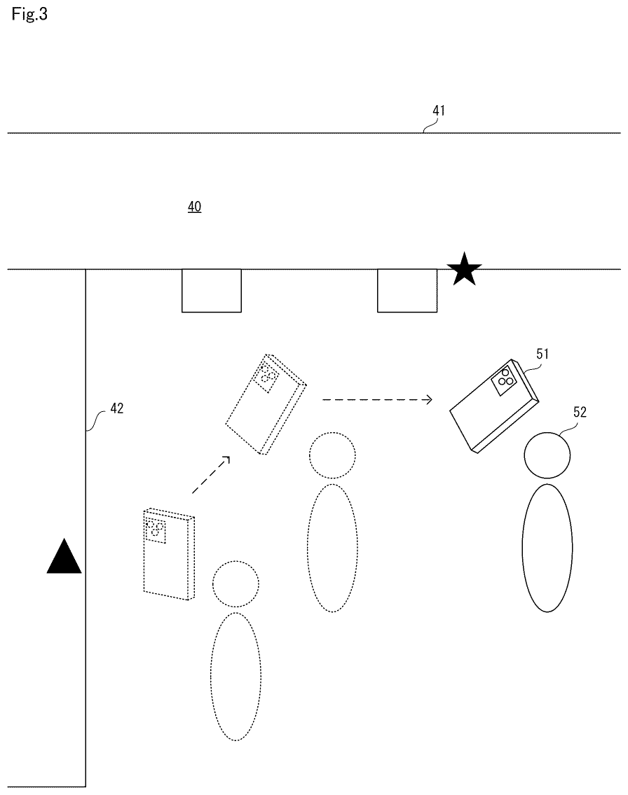

Next, a configuration and a function of an example of the information processing apparatus 10 will be specifically described with reference to FIGS. 2 to 4. FIG. 2 is a configuration diagram specifically illustrating a configuration of an example of the information processing apparatus. FIG. 3 is a diagram illustrating an example of a state of capturing moving image data used in the information processing apparatus.

As illustrated in FIG. 2, the information processing apparatus 10 includes a display unit 14 in addition to the data acquisition unit 11, the camera posture calculation unit 12, and the position identification unit 13 described above. The information processing apparatus 10 is connected to a database 20 and a terminal device 30 of the user so as to be able to perform data communication.

The database 20 stores three-dimensional data 21 of the object and moving image data 22. In the example embodiment, the object is a bridge. The object is not limited to a bridge, and may be an infrastructure other than a bridge, and other examples include a building, a factory, a large tank, and the like.

As the three-dimensional data 21, for example, three-dimensional point cloud data configured by a set of feature points of an object is used. The three-dimensional point cloud data is generated by, for example, a structure from motion (SfM) method using a large number of two-dimensional images of the object. Further, the three-dimensional point cloud data may be generated by a depth camera (LiDAR, point cloud scanner, etc.).

As illustrated in FIG. 3, in the example embodiment, moving image data is obtained by a photographer 52 capturing a moving image of a part of a floor slab 41 from a bridge pier 42 of a bridge 40 using an imaging device 51. In the example of FIG. 3, a smartphone with a camera is used as the imaging device 51.

The smartphone that is the imaging device 51 includes various sensors such as an inertial measurement unit (IMU). The smartphone calculates the camera posture using the sensor data output from the IMU for each frame at the time of capturing a moving image. The camera posture may be calculated as visual-inertial odometry (VIO) obtained by combining the image analysis result for each frame with the sensor data output from the IMU. Then, the smartphone adds information specifying the specified camera posture (first camera posture) to the frame. The first camera posture is relatively associated as an external parameter for each frame of the camera that has captured the moving image.

In the example of FIG. 3, the inspection portion is a part of the bottom surface of the floor slab 41 (★ mark in FIG. 3). The specific portion is set in a part of the bridge pier of the bridge 40 (▴ mark in FIG. 3). As the specific portion, a portion that is not missing in the three-dimensional point cloud data is used. A specific marking may be added to the specific portion in advance. Since the specific portion may be any portion as long as the specific portion is not lost in the three-dimensional point cloud data, high accuracy may be achieved by setting a plurality of specific portions, calculating a position relevant to the inspection portion from each specific portion, and averaging the plurality of calculated positions.

As illustrated in FIG. 3, the photographer 52 captures a moving image from a specific portion of the bridge pier 42 to an inspection portion of the floor slab 41 using a smartphone which is the imaging device 51. As a result, moving image data is generated. The generated moving image data is transmitted from the smartphone that is the imaging device 51 to the database 20.

In the example embodiment, the data acquisition unit 11 acquires the three-dimensional data 21 of the object and the moving image data 22 from the database 20. The data acquisition unit 11 outputs the acquired three-dimensional data 21 and moving image data 22 to the camera posture calculation unit 12.

In the example embodiment, the camera posture calculation unit 12 first compares the feature point of the frame including the specific portion in the moving image data with the feature point of the three-dimensional data to perform the collation, thereby specifying a region relevant to the specific portion in the three-dimensional data.

Specifically, the camera posture calculation unit 12 first calculates feature values such as a Haar-Like feature value, a HOG feature value, and a SIFT feature value in a frame including a specific portion. Next, the camera posture calculation unit 12 extracts a point at which the feature value is a predetermined value or more as a feature point. The frame of the specific portion is designated by the user in advance. The frame in the specific portion may be specified by extracting feature points from all the frames and then searching for a feature point with a designated feature value.

The camera posture calculation unit 12 executes matching between the feature point of the frame including the specific portion and each point constituting the three-dimensional point cloud data which is the three-dimensional data 21. As a method of the matching processing between the feature points, an existing method is used. Then, the camera posture calculation unit 12 specifies a plurality of feature points relevant to each of the three-dimensional data 21 and the frame image including the specific portion based on the matching result. The feature points are specified in the three-dimensional data 21 and the frame image, and are relevant to each other. The feature points relevant to each other are denoted as “relevant points” below.

Subsequently, the camera posture calculation unit 12 calculates a camera posture (second camera posture) in a portion including the plurality of relevant portions (a portion relevant to the specific portion) on the three-dimensional data 21 using the plurality of specified relevant points. The second camera posture is the camera posture in the three-dimensional data 21 as the world coordinate system. Specifically, the camera posture calculation unit 12 calculates the external parameter at the time of capturing the frame including the specific portion using the plurality of specified relevant points and the internal parameter of the camera at the time of capturing the frame including the specific portion.

Subsequently, the camera posture calculation unit 12 specifies the first camera posture held in the frame including the specific portion and the first camera posture held in the frame including the inspection portion from the moving image data 22. The frame including the inspection portion is designated by the user in advance. Further, the camera posture calculation unit 12 calculates a difference between the first camera posture held in the frame including the specific portion and the first camera posture held in the frame including the inspection portion.

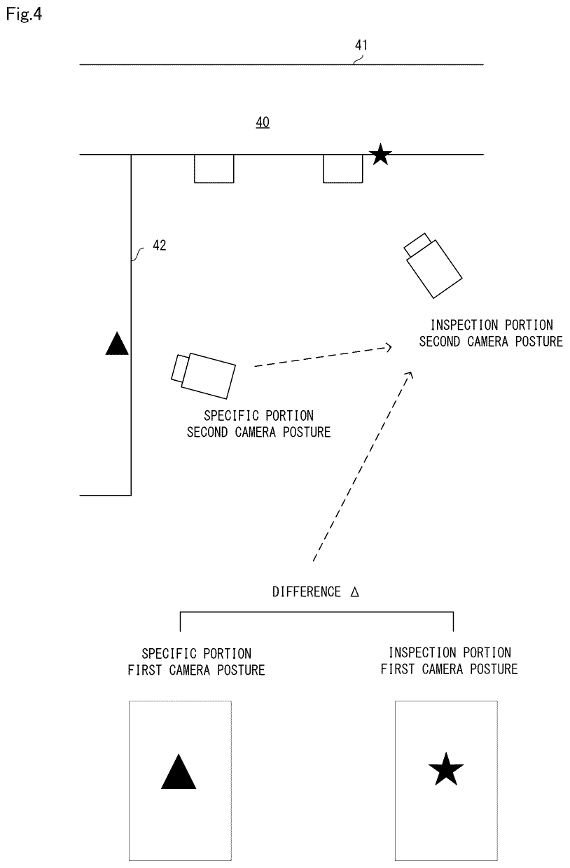

Then, the camera posture calculation unit 12 adds the calculated difference to the second camera posture in the portion relevant to the specific portion on the three-dimensional data. The second camera posture thus obtained is relevant to the second camera posture at a portion relevant to the inspection portion on the three-dimensional data. FIG. 4 is a diagram illustrating an example of processing in the camera posture calculation unit 12.

In the example embodiment, the position identification unit 13 calculates the coordinates of the portion relevant to the inspection portion on the three-dimensional data using the second camera posture (external parameter) in the portion relevant to the inspection portion on the three-dimensional data and the three-dimensional data 21. Specifically, the position identification unit 13 sets a region that can be included in the field of view of the camera using the second camera posture at a portion relevant to the inspection portion on the three-dimensional data, and sets a region where this region and the three-dimensional data 21 intersect as a region relevant to the inspection portion on the three-dimensional data.

The position identification unit 13 identifies an image or a point cloud relevant to the inspection portion on the three-dimensional data using the coordinates of the portion relevant to the calculated inspection portion, and outputs information indicating the identified image or point cloud to the display unit 14. In the example embodiment, even if a portion relevant to the inspection portion is missing in the three-dimensional data, a position advanced by a distance contacting the three-dimensional data in the posture direction of the camera from the position of the camera obtained in the second camera posture is regarded as a position on the three-dimensional data.

The display unit 14 displays the three-dimensional data of the object on the screen of the terminal device 30, for example. The display unit also displays a portion relevant to the inspection portion on the screen by superimposing the portion on the three-dimensional data using the information output by the position identification unit 13.

### [Apparatus Operation]

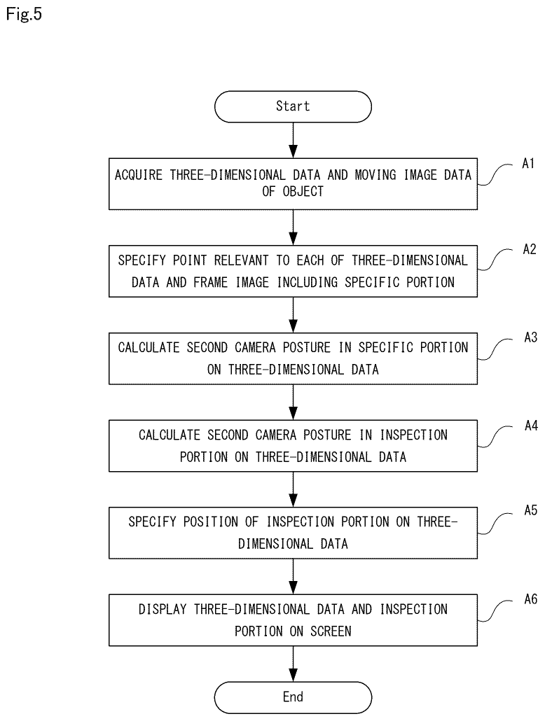

Next, an example of the operation of the information processing apparatus 10 will be described with reference to FIG. 5. FIG. 5 is a flowchart illustrating an example of the operation of the information processing apparatus 10. In the following description, FIGS. 1 to 4 will be appropriately referred to. In the example embodiment, the information processing method is performed by operating the information processing apparatus 10. Therefore, the description of the information processing method in the example embodiment is replaced with the following description of the operation of the information processing apparatus 10.

First, as a premise, the three-dimensional data 21 of the object is constructed, and the constructed three-dimensional data 21 is stored in the database 20. Moving image data obtained by photographing the inspection portion from the specific portion of the object is also stored in the database 20.

As illustrated in FIG. 5, first, the data acquisition unit 11 acquires the three-dimensional data 21 of the object and the moving image data 22 from the database 20 (step A1). The data acquisition unit 11 outputs the acquired three-dimensional data 21 and moving image data 22 to the camera posture calculation unit 12.

Next, the camera posture calculation unit 12 compares the feature point of the frame including the specific portion in the moving image data 21 with the feature point of the three-dimensional data to perform collation, thereby specifying a plurality of relevant points of the three-dimensional data and the frame image including the specific portion (step A2).

Specifically, in step A2, the camera posture calculation unit 12 first extracts a feature point from a frame including a specific portion, and executes matching between the extracted feature point and each point constituting the three-dimensional data 21. Then, the camera posture calculation unit 12 specifies a plurality of relevant points of each of the frame images including the specific portions on the three-dimensional data 21 based on the matching result.

Next, using the plurality of relevant points specified in step A2, the camera posture calculation unit 12 calculates a camera posture (second camera posture) in a portion (a portion relevant to a specific portion) including the plurality of relevant points on the three-dimensional data 21 (step A3).

Specifically, in step A3, the camera posture calculation unit 12 calculates the external parameter (second camera posture) of the camera at the time of capturing the frame including the specific portion, using the plurality of relevant points specified in step A2 and the internal parameter of the camera at the time of capturing the frame including the specific portion.

Next, the camera posture calculation unit 12 calculates the second camera posture in the portion relevant to the inspection portion on the three-dimensional data using the first camera posture held in the frame including the inspection portion and the second camera posture calculated in step A3 (step A4).

Specifically, in step A4, as illustrated in FIG. 4, the camera posture calculation unit 12 specifies the first camera posture held in the frame including the specific portion and the first camera posture held in the frame including the inspection portion from the moving image data 22. Further, the camera posture calculation unit 12 calculates a difference between the specified two first camera postures. Then, the camera posture calculation unit 12 adds the calculated difference to the second camera posture in the portion relevant to the specific portion on the three-dimensional data to calculate the second camera posture in the portion relevant to the inspection portion on the three-dimensional data.

Next, the position identification unit 13 identifies the position of the portion relevant to the inspection portion on the three-dimensional data using the second camera posture in the portion relevant to the inspection portion on the three-dimensional data calculated in step A4 (step A5).

Specifically, in step A5, the position identification unit 13 calculates coordinates of a portion relevant to the inspection portion on the three-dimensional data using the second camera posture calculated in step A4 and the three-dimensional data 21. The position identification unit 13 identifies an image or a point cloud relevant to the inspection portion on the three-dimensional data using the calculated coordinates, and outputs information indicating the identified image or point cloud to the display unit 14.

Next, the display unit 14 displays the three-dimensional data of the object on the screen of the terminal device 30, and further displays the portion specified in step A5 to be superimposed on the three-dimensional data (step A6).

### Effects of Example Embodiment

As described above, in the example embodiment, the second camera posture in the portion relevant to the inspection portion of the object on the three-dimensional data is calculated from the two first camera postures obtained in the moving image data and the second camera posture in the specific portion. Therefore, even if the data of the portion relevant to the inspection portion on the three-dimensional data is missing, the second camera posture of this portion is calculated. Therefore, according to the example embodiment, it is possible to align a capturing portion of an image obtained by capturing an object with a relevant portion of three-dimensional data without being affected by a state of the three-dimensional data of the object.

### [Modification]

Herein, a first modification to a third modification of the example embodiment will be described below.

### First Modification:

In the first modification, three-dimensional interpolation is performed on the three-dimensional data 21, and the three-dimensional data 21 on which the three-dimensional interpolation is performed is stored in the database 20. Three-dimensional interpolation is performed to add a face of a portion in which data is missing.

Examples of a three-dimensional interpolation method include a method using a machine learning model. The machine learning model in this case is constructed by machine learning using a three-dimensional model in which a part is missing and three-dimensional data (teacher data) without a missing. As a three-dimensional interpolation method, there is also a method of interpolating data on the assumption that a missing portion is a face continuous from the vicinity thereof.

In the first modification, first, the position identification unit 13 identifies a region that can be included in the field of view of the camera of the three-dimensional data 21 using the second camera posture in the portion relevant to the inspection portion on the three-dimensional data 21. Then, the position identification unit 13 sets a region intersecting the three-dimensional data among the identified regions as a position of a portion relevant to the inspection portion.

In the case of the first modification, the position of the portion relevant to the inspection portion on the three-dimensional data can be specified more accurately.

### Second Modification:

In the second modification, the moving image data also holds depth information for specifying the depth from the camera to the object in addition to the first camera posture of the camera for each frame. In the second modification, the imaging device 51 includes a depth camera such as LiDAR in addition to a normal camera, and measures the depth to the subject each time shooting is performed. In the second modification, the depth information to the subject only needs to include data at the time of frame photographing including the inspection portion.

Therefore, in the second modification, the position identification unit 13 identifies the position of the portion relevant to the inspection portion on the three-dimensional data using the second camera posture in the portion relevant to the inspection portion on the three-dimensional data and the depth information held in the frame including the inspection portion.

Also in the case of the second modification, the position of the portion relevant to the inspection portion on the three-dimensional data can be specified more accurately.

### Third Modification:

In the third modification, the depth information used in the second modification is calculated from a plurality of frame images including the inspection portion. At this time, the relative photographing position of each frame image is known from the sensor data from the IMU. For this reason, since the depth information in the frame including the inspection portion is obtained by the principle of the triangulation, the coordinates of the portion relevant to the inspection portion on the three-dimensional data can be calculated.

Also in the case of the third modification, the position of the portion relevant to the inspection portion on the three-dimensional data can be specified more accurately.

### [Program]

The program in the example embodiment may be a program that causes a computer to execute steps A1 to A6 illustrated in FIG. 5. When the program is installed and executed in the computer, the information processing apparatus 10 and the information processing method can be achieved. In this case, the processor of the computer functions as the data acquisition unit 11, the camera posture calculation unit 12, the position identification unit 13, and the display unit 14, and performs processing. Examples of the computer include a smartphone and a tablet terminal device in addition to a general-purpose PC and a server computer.

The program in the example embodiment may be executed by a computer system constructed by a plurality of computers. In this case, for example, each computer may function as any of the data acquisition unit 11, the camera posture calculation unit 12, the position identification unit 13, and the display unit 14.

### [Physical Configuration]

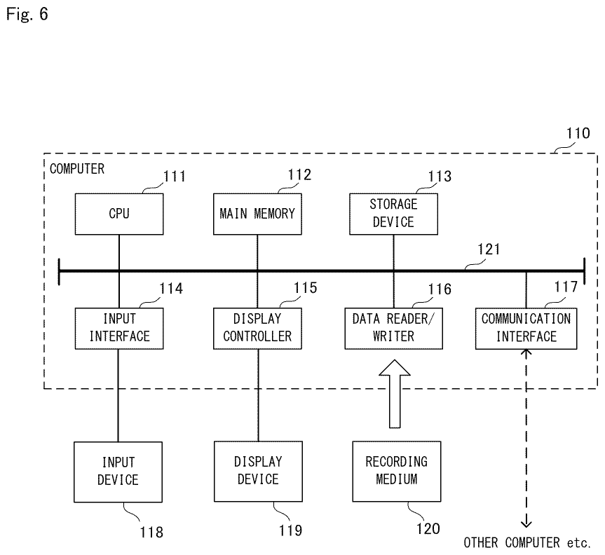

Here, a computer that achieves an information processing apparatus 10 by executing the programs in the example embodiments will be described with reference to FIG. 6. FIG. 6 is a block diagram illustrating an example of the computer that achieves the information processing apparatus.

As illustrated in FIG. 6, a computer 110 includes a central processing unit (CPU) 111, a main memory 112, a storage device 113, an input interface 114, a display controller 115, a data reader/writer 116, and a communication interface 117. These units are data-communicably connected to each other via a bus 121.

The computer 110 may include a graphics processing unit (GPU) or a field-programmable gate array (FPGA) in addition to the CPU 111 or instead of the CPU 111. In this aspect, the GPU or the FPGA can execute the program in the example embodiment.

The CPU 111 develops the program according to the example embodiment, which is stored in the storage device 113 and configured by a code group, in the main memory 112, and executes each code in a predetermined order to perform various operations. The main memory 112 is typically a volatile storage device such as a dynamic random access memory (DRAM).

The program according to the example embodiment is provided in a state of being stored in a computer-readable recording medium 120. The program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and the input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 to the recording medium 120. The communication interface 117 mediates data transmission between the CPU 111 and another computer.

Specific examples of the recording medium 120 include general-purpose semiconductor storage devices such as a Compact Flash (CF) (registered trademark) and a Secure Digital (SD), a magnetic recording medium such as a flexible disk, and an optical recording medium such as a compact disk read only memory (CD-ROM).

The information processing apparatus 10 can also be achieved by using hardware related to each unit, for example, an electronic circuit, instead of the computer in which the program is installed. Furthermore, a part of the information processing apparatus 10 may be achieved by a program, and the remaining part may be achieved by hardware. In the example embodiment, the computer is not limited to the computer illustrated in FIG. 6.

Some or all of the above-described example embodiments can be expressed by (Supplementary Note 1) to (Supplementary Note 18) described below, but are not limited to the following description.

### (Supplementary Note 1)

An information processing apparatus including:
a data acquisition unit that acquires moving image data generated by moving image capturing from a specific portion to an inspection portion of an object and holding a camera posture at a time of moving image capturing as a first camera posture for each frame;
a camera posture calculation unit configured to execute
collating a frame including the specific portion in the moving image data with three-dimensional data of the object, and calculating a camera posture in a portion relevant to the specific portion in the three-dimensional data as a second camera posture, and
calculating a second camera posture in a portion relevant to the inspection portion on the three-dimensional data using a first camera posture held in a frame including the inspection portion and a second camera posture in a portion relevant to the specific portion on the three-dimensional data; and
a position identification unit that identifies a position of a portion relevant to the inspection portion on the three-dimensional data using a second camera posture in a portion relevant to the inspection portion on the three-dimensional data.

### (Supplementary Note 2)

The information processing apparatus according to Supplementary Note 1, in which
the camera posture calculation unit is configured to execute:
calculating a difference between a first camera posture held in a frame including the specific portion and a first camera posture held in a frame including the inspection portion; and
calculating a second camera posture in a portion relevant to the inspection portion on the three-dimensional data by adding the calculated difference to a second camera posture at a portion relevant to the specific portion on the three-dimensional data.

### (Supplementary Note 3)

The information processing apparatus according to Supplementary Note 1, in which the camera posture calculation unit performs collation by comparing a feature point of a frame including the specific portion in the moving image data with a feature point of the three-dimensional data, thereby specifying a plurality of the feature points relevant to each of the three-dimensional data and a frame image including the specific portion, and calculates a camera posture in a portion including the plurality of specified feature points as the second camera posture.

### (Supplementary Note 4)

The information processing apparatus according to Supplementary Note 1, in which the position identification unit specifies a region included in a field of view of a camera of the three-dimensional data using a second camera posture in a portion relevant to the inspection portion on the three-dimensional data, and sets a position of the identified region as a position of a portion relevant to the inspection portion on the three-dimensional data.

### (Supplementary Note 5)

The information processing apparatus according to Supplementary Note 1, in which
the moving image data further holds depth information for specifying a depth from a camera to an object at least in a frame including the inspection portion, and
the position identification unit identifies a position of a portion relevant to the inspection portion on the three-dimensional data using a second camera posture in a portion relevant to the inspection portion on the three-dimensional data and the depth information held in a frame including the inspection portion.

### (Supplementary Note 6)

The information processing apparatus according to Supplementary Note 1, further including a display unit that displays the three-dimensional data on a screen,
in which the display unit also displays a portion relevant to the inspection portion on the screen in superposition with the three-dimensional data.

### (Supplementary Note 7)

An information processing method including:
a data acquisition step for acquiring moving image data generated by moving image capturing from a specific portion to an inspection portion of an object and holding a camera posture at a time of moving image capturing as a first camera posture for each frame;
a camera posture calculation step for executing
collating a frame including the specific portion in the moving image data with three-dimensional data of the object, and calculating a camera posture in a portion relevant to the specific portion in the three-dimensional data as a second camera posture, and
calculating a second camera posture in a portion relevant to the inspection portion on the three-dimensional data using a first camera posture held in a frame including the inspection portion and a second camera posture in a portion relevant to the specific portion on the three-dimensional data;
a camera posture calculation step; and
a position identification step for identifying a position of a portion relevant to the inspection portion on the three-dimensional data using a second camera posture in a portion relevant to the inspection portion on the three-dimensional data.

### (Supplementary Note 8)

The information processing method according to Supplementary Note 7, in which
in the camera posture calculation step,
a difference between a first camera posture held in a frame including the specific portion and a first camera posture held in a frame including the inspection portion is calculated, and
a second camera posture in a portion relevant to the inspection portion on the three-dimensional data is calculated by adding the calculated difference to a second camera posture at a portion relevant to the specific portion on the three-dimensional data.

### (Supplementary Note 9)

The information processing method according to Supplementary Note 7, in which in the camera posture calculation step, collation is performed by comparing a feature point of a frame including the specific portion in the moving image data with a feature point of the three-dimensional data, thereby specifying a plurality of the feature points relevant to each of the three-dimensional data and a frame image including the specific portion, and calculates a camera posture in a portion including the plurality of specified feature points as the second camera posture.

### (Supplementary Note 10)

The information processing method according to Supplementary Note 7, in which in the position identification step, a region included in a field of view of a camera of the three-dimensional data is identified using a second camera posture in a portion relevant to the inspection portion on the three-dimensional data, and sets a position of the identified region as a position of a portion relevant to the inspection portion on the three-dimensional data.

### (Supplementary Note 11)

The information processing method according to Supplementary Note 7, in which
the moving image data further holds depth information for specifying a depth from a camera to an object at least in a frame including the inspection portion, and
in the position identification step, a position of a portion relevant to the inspection portion on the three-dimensional data is identified using a second camera posture in a portion relevant to the inspection portion on the three-dimensional data and the depth information held in a frame including the inspection portion.

### (Supplementary Note 12)

The information processing method according to Supplementary Note 7, further including a display step for displaying the three-dimensional data on a screen,
in which in the display step, a portion relevant to the inspection portion is displayed on the screen in superposition with the three-dimensional data.

### (Supplementary Note 13)

A computer-readable recording medium having recorded therein a program containing commands for causing a computer to execute:
acquiring moving image data generated by moving image capturing from a specific portion to an inspection portion of an object and holding a camera posture at a time of moving image capturing as a first camera posture for each frame;
collating a frame including the specific portion in the moving image data with three-dimensional data of the object, and calculating a camera posture in a portion relevant to the specific portion in the three-dimensional data as a second camera posture;
calculating a second camera posture in a portion relevant to the inspection portion on the three-dimensional data using a first camera posture held in a frame including the inspection portion and a second camera posture in a portion relevant to the specific portion on the three-dimensional data; and
identifying a position of a portion relevant to the inspection portion on the three-dimensional data using a second camera posture in a portion relevant to the inspection portion on the three-dimensional data.

### (Supplementary Note 14)

The computer-readable recording medium according to Supplementary Note 13, in which
in the camera posture calculation step,
a difference between a first camera posture held in a frame including the specific portion and a first camera posture held in a frame including the inspection portion is calculated, and
a second camera posture in a portion relevant to the inspection portion on the three-dimensional data is calculated by adding the calculated difference to a second camera posture at a portion relevant to the specific portion on the three-dimensional data.

### (Supplementary Note 15)

The computer-readable recording medium according to Supplementary Note 13, in which in the camera posture calculation step, collation is performed by comparing a feature point of a frame including the specific portion in the moving image data with a feature point of the three-dimensional data, thereby specifying a plurality of the feature points relevant to each of the three-dimensional data and a frame image including the specific portion, and calculates a camera posture in a portion including the plurality of specified feature points as the second camera posture.

### (Supplementary Note 16)

The computer-readable recording medium according to Supplementary Note 13, in which in the position identification step, a region included in a field of view of a camera of the three-dimensional data is identified using a second camera posture in a portion relevant to the inspection portion on the three-dimensional data, and sets a position of the identified region as a position of a portion relevant to the inspection portion on the three-dimensional data.

### (Supplementary Note 17)

The computer-readable recording medium according to Supplementary Note 13, in which
the moving image data further holds depth information for specifying a depth from a camera to an object at least in a frame including the inspection portion, and
in the position identification step, a position of a portion relevant to the inspection portion on the three-dimensional data is identified using a second camera posture in a portion relevant to the inspection portion on the three-dimensional data and the depth information held in a frame including the inspection portion.

### (Supplementary Note 18)

The computer-readable recording medium according to Supplementary Note 13, further including a display step for displaying the three-dimensional data on a screen,
in which in the display step, a portion relevant to the inspection portion is displayed on the screen in superposition with the three-dimensional data.

While the present invention has been particularly shown and described with reference to example embodiments thereof, the present invention is not limited to these example embodiments. It will be understood by those of ordinary skill in the art that various changes in form and details may be made therein without departing from the spirit and scope of the present disclosure as defined by the claims.

As described above, according to the present disclosure, it is possible to align a capturing portion of an image obtained by capturing an object with a relevant portion of three-dimensional data without being affected by a state of the three-dimensional data of the object. The present disclosure is useful in fields where matching of three-dimensional data and images is required, for example, management of infrastructures.

1. An information processing apparatus comprising:
at least one memory storing instructions; and
at least one processor configured to execute the instructions to:
acquire moving image data generated by moving image capturing from a specific portion to an inspection portion of an object and holding a camera posture at a time of moving image capturing as a first camera posture for each frame;
execute collating a frame including the specific portion in the moving image data with three-dimensional data of the object, and calculate a camera posture in a portion relevant to the specific portion in the three-dimensional data as a second camera posture, and calculate a second camera posture in a portion relevant to the inspection portion on the three-dimensional data using a first camera posture held in a frame including the inspection portion and a second camera posture in a portion relevant to the specific portion on the three-dimensional data; and
identify a position of a portion relevant to the inspection portion on the three-dimensional data using a second camera posture in a portion relevant to the inspection portion on the three-dimensional data.

2. The information processing apparatus according to claim 1, wherein
at least one processor calculates a difference between a first camera posture held in a frame including the specific portion and a first camera posture held in a frame including the inspection portion; and calculates a second camera posture in a portion relevant to the inspection portion on the three-dimensional data by adding the calculated difference to a second camera posture at a portion relevant to the specific portion on the three-dimensional data.

3. The information processing apparatus according to claim 1, wherein
at least one processor performs collation by comparing a feature point of a frame including the specific portion in the moving image data with a feature point of the three-dimensional data, thereby specifying a plurality of the feature points relevant to each of the three-dimensional data and a frame image including the specific portion, and calculates a camera posture in a portion including the plurality of specified feature points as the second camera posture.

4. The information processing apparatus according to claim 1, wherein
at least one processor specifies a region included in a field of view of a camera of the three-dimensional data using a second camera posture in a portion relevant to the inspection portion on the three-dimensional data, and sets a position of the identified region as a position of a portion relevant to the inspection portion on the three-dimensional data.

5. The information processing apparatus according to claim 1, wherein
the moving image data further holds depth information for specifying a depth from a camera to an object at least in a frame including the inspection portion, and
at least one processor identifies a position of a portion relevant to the inspection portion on the three-dimensional data using a second camera posture in a portion relevant to the inspection portion on the three-dimensional data and the depth information held in a frame including the inspection portion.

6. The information processing apparatus according to claim 1, wherein
at least one processor displays the three-dimensional data on a screen, also displays a portion relevant to the inspection portion on the screen in superposition with the three-dimensional data.

7. An information processing method for causing a computer to execute:
acquiring moving image data generated by moving image capturing from a specific portion to an inspection portion of an object and holding a camera posture at a time of moving image capturing as a first camera posture for each frame;
collating a frame including the specific portion in the moving image data with three-dimensional data of the object, and calculating a camera posture in a portion relevant to the specific portion in the three-dimensional data as a second camera posture;
calculating a second camera posture in a portion relevant to the inspection portion on the three-dimensional data using a first camera posture held in a frame including the inspection portion and a second camera posture in a portion relevant to the specific portion on the three-dimensional data; and
identifying a position of a portion relevant to the inspection portion on the three-dimensional data using a second camera posture in a portion relevant to the inspection portion on the three-dimensional data.

8. The information processing method according to claim 7, wherein
in the calculating of the second camera posture,
a difference between a first camera posture held in a frame including the specific portion and a first camera posture held in a frame including the inspection portion is calculated, and
a second camera posture in a portion relevant to the inspection portion on the three-dimensional data is calculated by adding the calculated difference to a second camera posture at a portion relevant to the specific portion on the three-dimensional data.

9. The information processing method according to claim 7, wherein in the calculating of the second camera posture, collation is performed by comparing a feature point of a frame including the specific portion in the moving image data with a feature point of the three-dimensional data, thereby specifying a plurality of the feature points relevant to each of the three-dimensional data and a frame image including the specific portion, and calculates a camera posture in a portion including the plurality of specified feature points as the second camera posture.

10. The information processing method according to claim 7, wherein in the identifying of the position, a region included in a field of view of a camera of the three-dimensional data is identified using a second camera posture in a portion relevant to the inspection portion on the three-dimensional data, and sets a position of the identified region as a position of a portion relevant to the inspection portion on the three-dimensional data.

11. The information processing method according to claim 7, wherein
the moving image data further holds depth information for specifying a depth from a camera to an object at least in a frame including the inspection portion, and
in the identifying of the position, a position of a portion relevant to the inspection portion on the three-dimensional data is identified using a second camera posture in a portion relevant to the inspection portion on the three-dimensional data and the depth information held in a frame including the inspection portion.

12. The information processing method according to claim 7, further comprising:
displaying the three-dimensional data on a screen; and
at that time, displaying a portion relevant to the inspection portion on the screen in a superimposed manner on the three-dimensional data.

13. A non-transitory computer-readable recording medium having recorded therein a program for causing a computer to execute:
acquiring moving image data generated by moving image capturing from a specific portion to an inspection portion of an object and holding a camera posture at a time of moving image capturing as a first camera posture for each frame;
collating a frame including the specific portion in the moving image data with three-dimensional data of the object, and calculating a camera posture in a portion relevant to the specific portion in the three-dimensional data as a second camera posture;
calculating a second camera posture in a portion relevant to the inspection portion on the three-dimensional data using a first camera posture held in a frame including the inspection portion and a second camera posture in a portion relevant to the specific portion on the three-dimensional data; and
identifying a position of a portion relevant to the inspection portion on the three-dimensional data using a second camera posture in a portion relevant to the inspection portion on the three-dimensional data.

14. The non-transitory computer-readable recording medium according to claim 13, wherein
in the calculating of the second camera posture,
a difference between a first camera posture held in a frame including the specific portion and a first camera posture held in a frame including the inspection portion is calculated, and
a second camera posture in a portion relevant to the inspection portion on the three-dimensional data is calculated by adding the calculated difference to a second camera posture at a portion relevant to the specific portion on the three-dimensional data.

15. The non-transitory computer-readable recording medium according to claim 13, wherein in the calculating of the second camera posture, collation is performed by comparing a feature point of a frame including the specific portion in the moving image data with a feature point of the three-dimensional data, thereby specifying a plurality of the feature points relevant to each of the three-dimensional data and a frame image including the specific portion, and calculates a camera posture in a portion including the plurality of specified feature points as the second camera posture.

16. The non-transitory computer-readable recording medium according to claim 13, wherein in the identifying of the position, a region included in a field of view of a camera of the three-dimensional data is identified using a second camera posture in a portion relevant to the inspection portion on the three-dimensional data, and sets a position of the identified region as a position of a portion relevant to the inspection portion on the three-dimensional data.

17. The non-transitory computer-readable recording medium according to claim 13, wherein
the moving image data further holds depth information for specifying a depth from a camera to an object at least in a frame including the inspection portion, and
in the identifying of the position, a position of a portion relevant to the inspection portion on the three-dimensional data is identified using a second camera posture in a portion relevant to the inspection portion on the three-dimensional data and the depth information held in a frame including the inspection portion.

18. The non-transitory computer-readable recording medium according to claim 13, wherein
the three-dimensional data is displayed on a screen; and
at that time, a portion relevant to the inspection portion is displayed on the screen in a superimposed manner on the three-dimensional data.
